(19) United States
(12) Patent Application Publication
(10) Pub. No.: US 2020/0187482 A1
(43) Pub. Date: Jun. 18, 2020

(54) Smart Insect Exterminator Kit

(71) Applicant: Kenneth Waruta Njuguna, SHREWSBURY, MA (US)

(72) Inventor: Kenneth Waruta Njuguna, SHREWSBURY, MA (US)

(21) Appl. No.: 16/588,824

(22) Filed: Sep. 30, 2019

Related U.S. Application Data
(63) Continuation-in-part of application No. 29/680,435, filed on Feb. 15, 2019.
(60) Provisional application No. 62/778,742, filed on Dec. 12, 2018.

(51) Int. Cl. A01M 1/20

(52) U.S. Cl. CPC A01M 1/20

(57) ABSTRACT

The present invention provides a smart insect exterminating apparatus. The apparatus utilizes a housing, an insect extermination chamber, a poison reservoir, a fluid transfer mechanism, and a processor to allow a user to set up the apparatus. The apparatus traps the insects within the housing. The apparatus neutralizes the entrapped insects. The user can then dispose the insect refuse in the apparatus. The fluid transfer mechanism connected in between the poison reservoir and the insect extermination chamber is activated through either a time increment and/or sensory means, automatically dispensing insect poison from the poison reservoir to the insect extermination chamber, neutralizing insects trapped within insect extermination chamber. A wireless communication device is provided which permits a user to pair a corresponding client device to remotely configure and/or monitor the apparatus therefore, not requiring the user to be at the site of deployment if the apparatus needs to be reconfigured.

The current application claims a priority to the U.S. Provisional Patent application Ser. No. 62/778,742 filed on Dec. 12, 2018.

### FIELD OF THE INVENTION

The present invention relates generally to an insect extermination kit, particularly a programmed extermination kit that is centralized to a single container with an interval driven poison emission system.

### BACKGROUND OF THE INVENTION

In present times, there is an ever-growing need for controlling pests in areas inhabited by man. Common crawling insects, such as ants and cockroaches, come in various shapes and sizes. These crawling insects oftentimes intrude into dwellings through cracks, and often release pheromones, leaving a track for additional crawling insects to follow. Once the crawling insects have infiltrated the dwelling, they will often reside and thrive in dark, spatially limiting environments such as cabinets, drawers, crawlspaces, and/or any other suitable area for crawling insects to travel and hide. Controlling these insects can be an exhaustive and dangerous task. For example, one method of insect control is spraying insecticides in an affect area. Misuse and/or mis-appliance of these chemical agents have been recorded in history to pose danger of exposure to the dwellers of the applied area. Additionally, pest kits, traps, and similar are known to the art. However, these particular pest mitigating measures are constrained to mechanical and passive poisoning systems that further employ a generic entryway or portal into the extermination portion of the trap. The systems thereof do not possess a reliable means of conveying the capacity of the trap if the trap is located in a dark recess where pests are more likely to cross the trap.

The present invention aims to solve these problems. The present invention features an autonomous and smart means of exterminating insects, especially in spatially limited and dark environments. The present invention features a housing that employs an insect entrapment entryway, allowing insects to easily enter and confine the insects an extermination chamber. The present invention features a fluid transfer mechanism that administers insect poison inside the insect extermination chamber, being able to dispense insect poison through timely increments and/or through sensory means. Additionally, the present invention is electronically configurable, featuring a user interface to set various control parameters including, but are not limited to on/off toggling, set timer threshold, set indicator threshold, notification settings, and/or any other suitable means. The present invention features illuminated indicators suited for displaying the various statuses of the apparatus in dark environments. These statuses can include but are not limited to full insect extermination chamber, low batter, power on/off, and/or any other suitable statuses. The present invention can also pair with a corresponding client device such as a smartphone, computer, laptop, and/or any other suitable user interaction device. The present invention can accommodate various power sources such as but are not limited to rechargeable/interchangeable battery packs, USB/power cords, solar power, and/or any other power sources. Furthermore, the present invention features replaceable poison canisters and insect extermination bags, allowing for continuous usage of the apparatus.

### SUMMARY OF THE INVENTION

The present invention provides a smart insect exterminating apparatus. The apparatus utilizes a housing 100, an insect extermination chamber, a poison reservoir, a fluid transfer mechanism 210, and a processor 220 to allow a user to set up the apparatus. The apparatus will then trap the insects within the housing 100. The apparatus will then neutralize the entrapped insects. The user can then dispose of the insect refuse in the apparatus.

The user can configure the smart insect exterminating apparatus using the corresponding electronics panel 271. Once configured, the apparatus is positioned along a dark and spatially limiting area known to contain the targeted insects. The housing 100 comprises an entrapment aperture 105, trapping insects within the insect extermination chamber.

Once the insects are trapped, the fluid transfer mechanism 210 connected in between the poison reservoir 200 and the insect extermination chamber is activated through either a time increment and/or sensory means, automatically dispensing insect poison from the poison reservoir 200 to the insect extermination chamber, neutralizing insects trapped within the insect extermination chamber.

In one embodiment, the smart insect exterminating apparatus can further comprise various indicators, working in conjunction with optical, and/or weight sensors in monitoring the status of how much insect refuse has been collected and indicating the status of the monitoring to the user. Furthermore, sensors can be connected to the poison reservoir, allowing the user to monitor the status of how much insect poison is left. Once the insect extermination chamber is full, the housing 100 can then be opened to replace the insect extermination chamber. Additionally, the poison reservoir 200 can also be replaced if empty.

A wireless communication device 280 is provided which permits a user to pair a corresponding client device to remotely configure and/or monitor the apparatus therefore, not requiring the user to be at the site of deployment if the apparatus needs to be reconfigured.

### BRIEF DESCRIPTION OF THE DRAWINGS

FIG. 1 is a perspective view of the apparatus in a closed configuration.

FIG. 2 is a perspective view of the apparatus in an opened configuration where an insect extermination chamber and a poison reservoir are positioned in the apparatus.

FIG. 3 is a perspective view of the apparatus in an opened configuration where the extermination chamber and the poison reservoir are removed in the apparatus.

FIG. 4 is a front view of the apparatus of the present invention.

FIG. 5 is a rear view of the apparatus of the present invention.

FIG. 6 is a right view of the apparatus of the present invention.

FIG. 7 is a left view of the apparatus of the present invention.

FIG. 8 is a top view of the apparatus of the present invention.

FIG. 9 is a bottom view of the apparatus of the present invention.

FIG. 10 is a circuit diagram of the electronic component of the present invention.

FIG. 11 is a general flow diagram illustrating the operation of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole. In the present invention, the word “insect” is used to mean not only true insects, all of which are hexapods, or six-legged, including, but not limited to scorpions, spiders, and mites, but also bugs and creatures, often confounded with insects, belonging to the classes known as ‘Arachnida’ and ‘Myriapoda’, including, but not limited to, centipedes and millipedes.

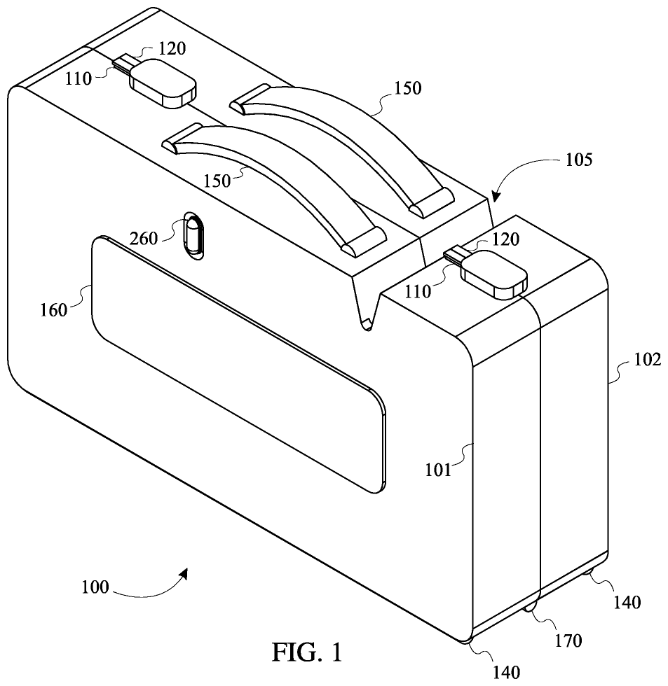

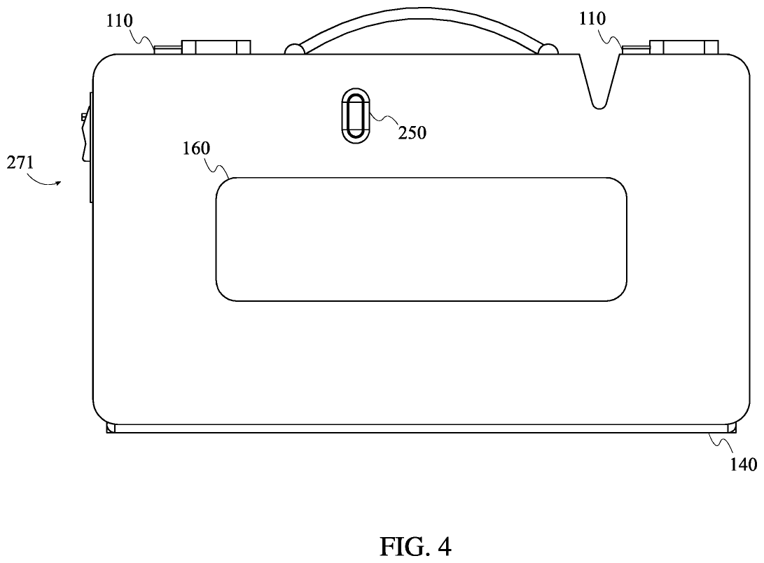

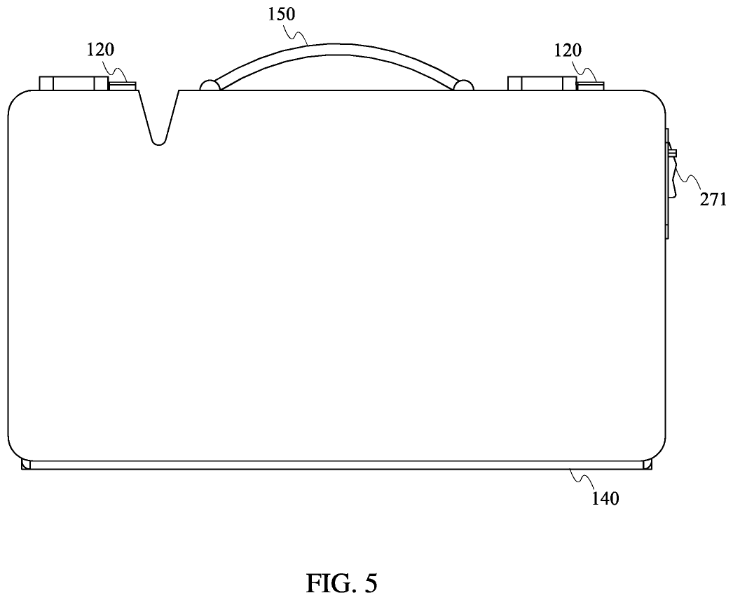

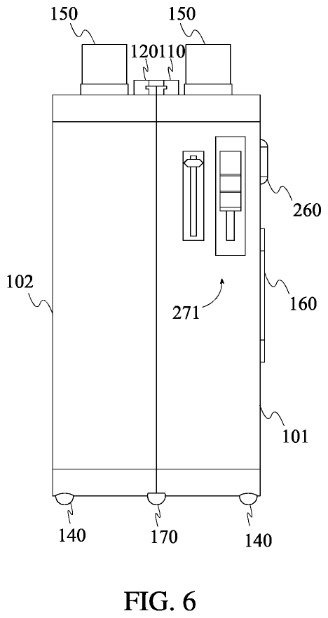

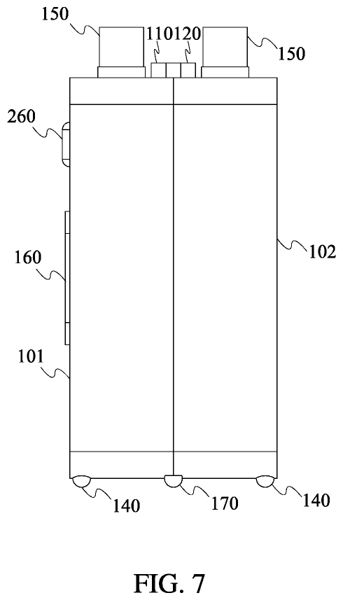

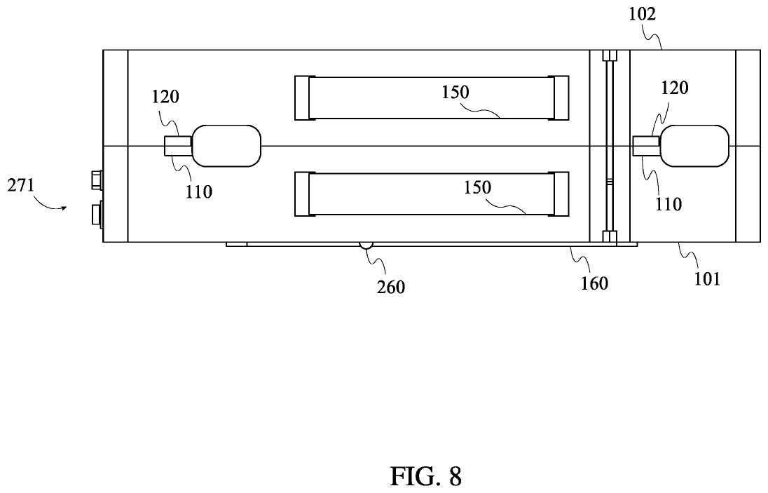

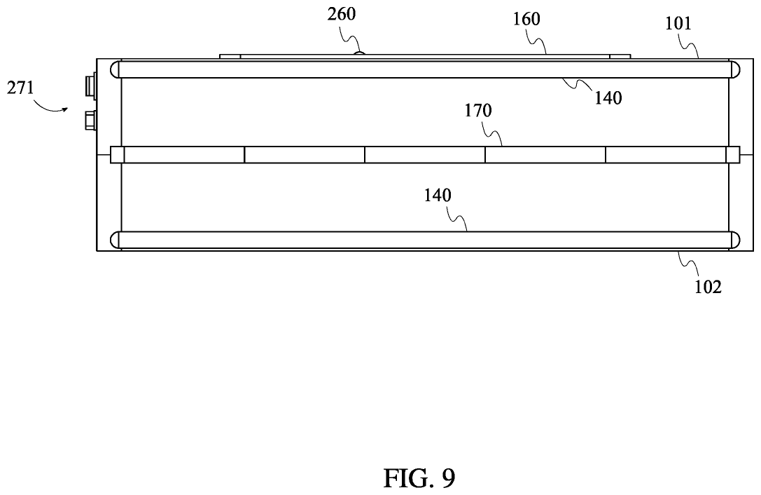

In reference to FIGS. 1-11, the present invention is a smart insect extermination kit. More specifically, the insect extermination kit provides an autonomous means of trapping and neutralizing insects. The insect extermination kit generally comprises a housing 100, an insect extermination chamber 180, a poison reservoir 200, a fluid transfer mechanism 210, and a processor 220.

In reference to FIGS. 1-9, the housing 100 is the main body of the insect extermination kit. The housing 100 serves as a protective casing for the insect extermination kit. In the preferred embodiment of the present invention, the housing 100 takes form of any suitable, rigid casing that facilitates the protection and containment of its components. In the preferred embodiment of the present invention, the housing 100 can be made out of durable material that resists corrosion/wear from environmental factors such as, but are not limited to moisture, ultra-violet rays, and/or any other relevant environmental hazard. In one embodiment, the housing 100 can be an injection molded casing made out of a durable polymer such as, but not limited to impact resistant ABS, nylon composite, and/or any other suitable material. In various embodiments, the housing 100 can be made out of milled metal, wood, polymer, and/or any other suitable material. The housing 100 comprises an entrapment aperture 105.

The entrapment aperture 105 traverses through the housing 100, serving as an opening that allows insects to ingress the extermination cavity 103 of the housing 100. The entrapment aperture 105 takes form of any insect trap that allows ingress of insects within the insect extermination chamber and prevents egress of insects from within the insect extermination chamber 180. In the preferred embodiment of the present invention, the entrapment aperture 105 may take the form of a funnel-shaped, tapered entryway, but can take form of any suitable specific geometry that promotes the influx of insects within the housing 100 while preventing the escape of the entrapped insects. The housing 100 further comprises a first portion 101, a second portion 102, an extermination cavity 103, and a canister cavity 104.

The first portion 101 is one half of the housing 100. The first portion 101 of the housing 100 serves as the container half of the housing 100 that secures the insect extermination chamber 180 and the poison reservoir 200 within the housing 100. The second portion 102 is the other half of the housing 100. The second portion 102 of the housing 100 serves as the cap half of the housing 100 that closes off the first portion 101 of the housing 100, securing the insect extermination chamber 180 and the poison reservoir 200 within the housing 100. In the preferred embodiment of the present invention, the first portion 101 and the second portion 102 are selectively engaged with each other between an open configuration and a closed configuration. This allows the components enclosed by the housing 100 to be accessed by the user for servicing. It should be understood, however, that various means for facilitating user access to the components of the present invention internal to the housing 100, specifically the insect extermination chamber and the poison reservoir 200, may be comprised in different embodiments.

The extermination cavity 103 is positioned within the housing 100. More specifically, the extermination cavity 103 serves as a space that receives the insect extermination chamber 180 within the housing 100. The canister cavity is positioned within the housing 100. More specifically, the extermination cavity 103 secures the corresponding poison reservoir 200 within the housing 100. In the preferred embodiment of the present invention, the extermination cavity 103 and the canister cavity 104 are positioned within the housing 100.

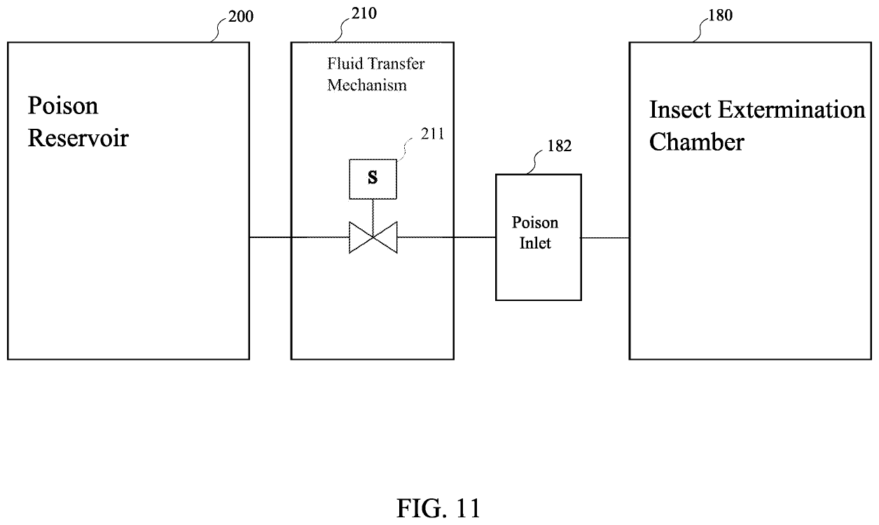

In reference to FIG. 11, the poison reservoir 200 is positioned within the housing 100, adjacent to the insect extermination chamber 180. The poison reservoir 200 contains an insect poison solution. In the preferred embodiment of the present invention, the poison reservoir 200 can take form of an aerosol insecticide receptacle, wherein the insect poison solution that resides within the aerosol insecticide receptacle will be dispensed by the fluid transfer mechanism 210. In the preferred embodiment of the present invention, the insect poison solution contains ingredients that will kill insects on contact.

In reference to FIG. 11, the fluid transfer mechanism 210 is connected between the poison reservoir 200 and the poison inlet 182 of the insect extermination chamber 180. The fluid transfer mechanism 210 is any mechanism that can transfer insect poison solution from the poison reservoir 200 to the insect extermination chamber 180. In the preferred embodiment of the present invention, the fluid transfer mechanism 210 takes form of an electronic aerosol dispensing mechanism. In another embodiment of the present invention, the fluid transfer mechanism 210 can also take form of an electronic pump mechanism. The fluid transfer mechanism 210 comprises a valve actuator.

In reference to FIG. 11, the valve actuator 211 is electronically connected to the processor. In the preferred embodiment of the present invention, the valve actuator 211 can be an electronic solenoid valve. When the fluid transfer mechanism 210 is activated, the electronic solenoid valve opens, releasing the insect poison solution from the position reservoir to the insect extermination chamber 180.

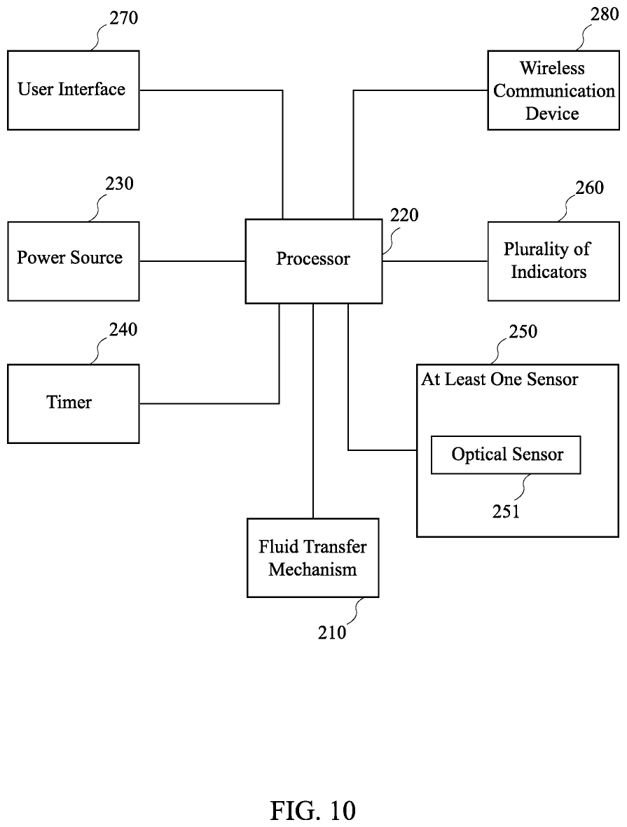

In reference to FIG. 10, the processor 220 is operatively connected to the fluid transfer mechanism 210. More specifically, the processor 220 is the electronic control unit that operates the fluid transfer mechanism 210 through timely and/or sensory activation. The processor 220 also distributes power from the power source 230 to all relevant electrical components of the present invention. The processor 220 also monitors the collected insect refuse within the insect extermination chamber 180, being able to collect weight/volume data based on sensory inputs.

In reference to FIGS. 1-11, the insect extermination kit further comprises a first plurality of body connectors 110, a second plurality of body connectors 120, a plurality of feet 140, at least one handle, a label 160, a hinge 170, a closure 190, a power source 230, a timer 240, at least one sensor 250, a plurality of indicators 260, a user interface 270, and a wireless communication device 280.

The first plurality of body connectors 110 is connected to the first portion 101 of the housing 100. More specifically, the first plurality of body connectors 110 serves as securement tabs that selectively engage with the second plurality of body connectors 120.

The second plurality of body connectors 120 is connected to the second portion 102 of the housing 100. More specifically, the second plurality of body connectors 120 serves as securement tabs, where the first plurality of body connectors 110 is engaged with the second plurality of body connectors 120 in the closed configuration. In the preferred embodiment of the present invention, the body connectors can employ a snap fitting means of conjoining the first portion 101 of the housing 100 to the second portion 102 of the housing 100. Other mounting means can also be employed, such as, but not limited to, self-locating geometry, conventional fasteners, tolerance fitting, locking latches, clasps, and/or any other suitable means.

The plurality of feet 140 is externally connected to the housing 100. More specifically, the plurality of feet 140 serves as stabilizing members that secures the housing 100 along a flat surface. In the preferred embodiment of the present invention, the plurality of feet 140 permits the insect extermination kit to stand upright, orienting the first half and the second half of the housing vertically from the ground.

The plurality of handles 150 is externally connected to the housing 100, allowing the user to grasp and handle the insect extermination kit assembly. In the preferred embodiment of the present invention, the plurality of handles 150 may take the form of carrying handles integrated to the first portion 101 of the housing 100 and the second portion 102 of the housing 100. In another embodiment of the present invention, the plurality of handles 150 may take the form of any other suitable means for the user to carry the insect extermination kit such as, but not limited to lanyards, hooks, grips, and/or any other suitable means. The label 160 is externally connected to the housing 100. More specifically, the label 160 provides a legible surface for marking indicium. This indicium can include, but are not limited to ownership, product, classification, pest specialization, and/or any other suitable means.

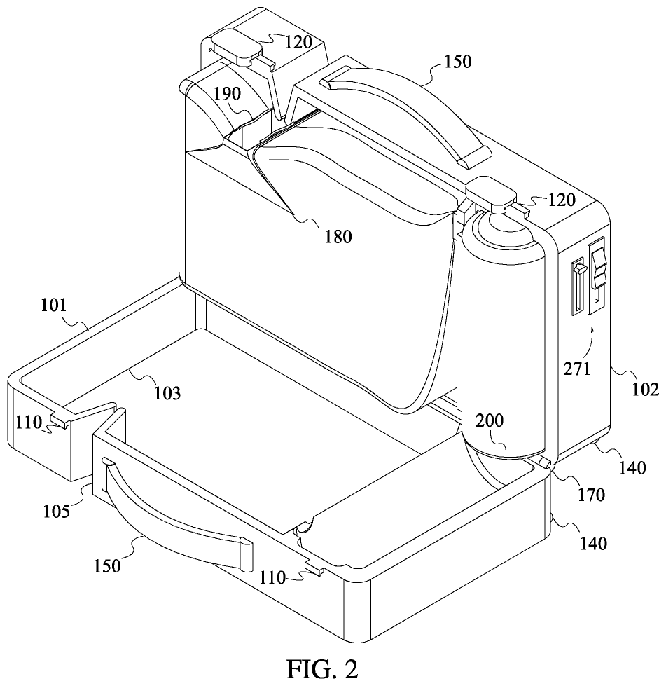

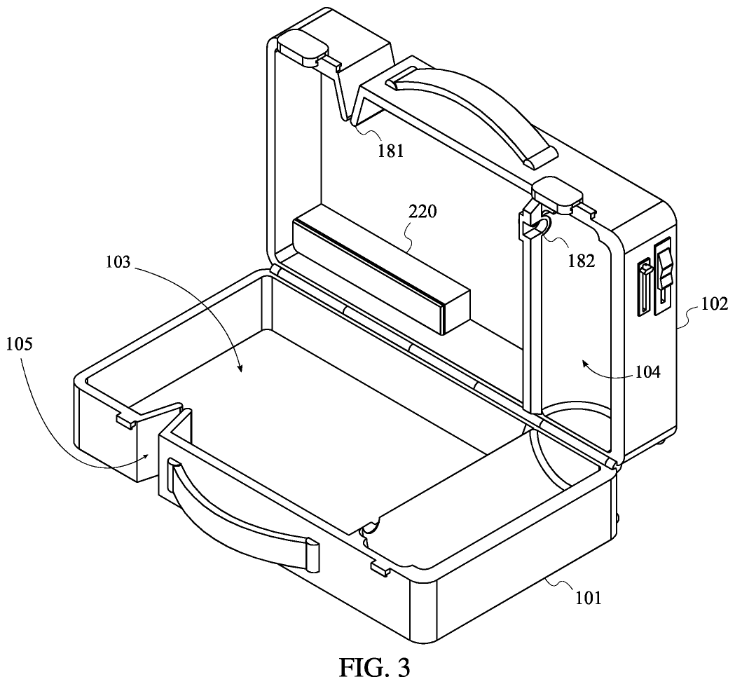

The hinge 170 is positioned between the first portion 101 of the housing 100 and the second portion 102 of the housing 100. More specifically, the first portion 101 of the housing 100 and the second portion 102 of the housing 100 are pivotally connected to each other through the hinge 170. Additionally, the hinge 170 is positioned opposite to the first plurality of body connectors 110 and the second plurality of body connectors 120 along the first portion 101 of the housing 100 and the second portion 102 of the housing 100, respectively. The hinge 170 allows the first portion 101 of the housing 100 and the second portion 102 of the housing 100 to rotate relative to each other in order to be selectively positioned by the user between the open configuration shown in FIGS. 2-3, and the closed configuration shown in FIG. 1.

The insect extermination chamber 180 is positioned within the housing 100; more specifically, the insect extermination chamber 180 is positioned within the extermination cavity 103. In the preferred embodiment, the insect extermination chamber 180 is a removable flexible bag that acts as a liner for the extermination cavity 103, allowing the user to replace the insect extermination chamber 180 when full of insect refuse.

In reference to FIG. 3, the insect extermination chamber 180 comprises an insect inlet 181 and a poison inlet 182. The insect inlet 181 is positioned adjacent to the entrapment aperture 105 of the housing 100. More specifically, the insect inlet 181 serves as a first opening to the insect extermination chamber 180 that corresponds to an entryway to the entrapment aperture 105.

In reference to FIG. 11, the poison inlet 182 is positioned adjacent to the fluid transfer mechanism 210. More specifically, the poison inlet 182 serves as a second opening to the insect extermination chamber 180 that corresponds to an output end of the fluid transfer mechanism 210.

The closure 190 is perimetrically positioned along the insect inlet 181 of the insect extermination chamber 180. More specifically, in the preferred embodiment the closure 190 is a drawstring that allows the user to tie and close off the insect extermination chamber 180 for disposal. In various embodiments, the closure 190 can be any suitable component that can close off the insect extermination chamber 180 for disposal, such as, but not limited to adhesive strips, connection tabs, and/or any other suitable means.

The power source 230 is electronically connected to the processor 220. The power source 230 provides a means of supplying electrical power to the electronic components of the insect kit. In one embodiment of the present invention, the power source 230 can take form of a cordless power source 230, such as, but not limited to rechargeable battery packs, solar panels, or other suitable portable sources of electric power. In another embodiment of the present invention, the power source 230 may take the form of a corded power source 230, relying on a wall outlet, USB cord, or other external power source 230 to which the present invention may be connected.

The timer 240 is operatively connected to the processor 220, wherein the processor 220 is configured to activate the fluid transfer mechanism 210 based on input received from the timer 240. In this instance, the timer-actuated insect extermination kit will dispense insect poison in a timely manner.

In the preferred embodiment of the present invention, the insect extermination kit comprises at least one sensor 250. The sensor is operatively connected to the processor 220, wherein the processor 220 is configured to activate the fluid transfer mechanism 210 based on input received from the at least one sensor 250. In the preferred embodiment of the present invention, the at least one sensor 250 comprises an optical sensor 251, activating the fluid transfer mechanism 210 upon detection of insects entering the insect extermination chamber 180 by the optical sensor. In another embodiment, the insect extermination kit can also comprise a proximity sensor positioned within the insect extermination chamber 180. This allows the insect extermination chamber 180 to detect how much insect refuse is in the insect extermination chamber 180. In another embodiment, the insect extermination kit can also comprise a weight sensor that measures the weight of the insect refuse within the insect extermination chamber 180. In one embodiment, a sensor can be connected to the poison reservoir, allowing the user to monitor the amount of insect poison left.

The plurality of indicators 260 is electronically connected to the processor 220. Additionally, the plurality of indicators 260 is externally connected to the housing 100. More specifically, in some embodiments the plurality of indicators 260 may take the form of LED lights that may be used to convey the various statuses of the insect extermination kit. In the preferred embodiment of the present invention, the plurality of indicators 260 may display an LED light to indicate various statuses, such as, but not limited to, on or off status of the insect extermination kit, insect extermination chamber full, empty or low poison reservoir, low power, and/or any other relevant indicators.

The user interface 270 is externally connected to the housing 100. Additionally, the user interface 270 is electronically connected to the processor. More specifically, the user interface 270 allows the user to configure the parameters dictated by the processor 220. These controllable parameters can include, but are not limited to different time intervals, sensory sensitivity, toggle on/off, and/or any other suitable parameters. In some embodiments, the user interface 270 may comprise one or more switches, dials, sliders, or other control elements that allow the user to provide input to the processor 220 in order to control the operation of the present invention. In other embodiments, any other suitable user interface 270 elements may be utilized. In the preferred embodiment, the user interface 270 comprises an electronics panel 271.

The electronics panel 271 is externally connected to the housing 100. More specifically, the electronics panel 271 is connected to a lateral wall of the first portion 101 of the housing 100. The electronics panel 271 takes form of an integrated control dashboard that allows the user to configure the parameters dictated by the processor. In some embodiments, the user interface 270 may additionally or alternatively comprise various physical control elements such as, but not limited to, buttons, toggles, or sliders.

The wireless communication device 280 is electronically connected to the processor 220. The wireless communication device 280 may take the form of any wireless communication module such as, but not limited to, wifi, Bluetooth, cellular network, or any other suitable device. The wireless communication device 280 allows the insect extermination kit to be paired with a corresponding device, such as a smartphone, computer, laptop, and/or any other suitable means. This, along with the corresponding software, allows the user to remotely control and/or configure the parameters dictated by the processor.

Although the invention has been explained in relation to its preferred embodiment, it is to be understood that many other possible modifications and variations can be made without departing from the spirit and scope of the invention as hereinafter claimed.

What is claimed is:

1. An insect extermination kit comprising:
a housing;
an insect extermination chamber;
a poison reservoir;
a fluid transfer mechanism;
a processor;
the housing comprising an entrapment aperture;
the insect extermination chamber comprising an insect inlet and a poison inlet;
the insect extermination chamber and the poison reservoir being positioned within the housing;
the insect inlet of the insect extermination chamber being positioned adjacent to the entrapment aperture of the housing;
the fluid transfer mechanism being connected between the poison reservoir and the poison inlet of the insect extermination chamber;
the processor being operatively connected to the fluid transfer mechanism; and
the entrapment aperture traversing through the housing.

2. The insect extermination kit as claimed in claim 1 comprising:
the housing comprising a first portion, a second portion, an extermination cavity, and a canister cavity;
a first plurality of body connectors;
a second plurality of body connectors;
a plurality of feet;
at least one handle;
a label;
the first portion and the second portion being selectively engaged with each other between an open configuration and a closed configuration;
the first plurality of body connectors being connected to the first portion of the housing;
the second plurality of body connectors being connected to the second portion of the housing;
the first plurality of body connectors being engaged with the second plurality of body connectors in the closed configuration;
the extermination cavity and the canister cavity being positioned within the housing;
the plurality of feet being externally connected to the housing;
the plurality of handles being externally connected to the housing; and
the label being externally connected to the housing.

3. The insect extermination kit as claimed in claim 2 comprising:
a hinge;
the first portion of the housing and the second portion of the housing being pivotally connected to each other through the hinge; and
the hinge being positioned opposite to the first plurality of body connectors and the second plurality of body connectors along the first portion of the housing and the second portion of the housing, respectively.

4. The insect extermination kit as claimed in claim 1 comprising:
the fluid transfer mechanism comprising a valve actuator; and
the valve actuator being electronically connected to the processor.

5. The insect extermination kit as claimed in claim 1 comprising:
a plurality of indicators;
a power source;
the plurality of indicators being electronically connected to the processor;
the plurality of indicators being externally connected to the housing; and
the power source being electronically connected to the processor.

6. The insect extermination kit as claimed in claim 1 comprising:
a timer; and
the timer being operatively connected to the processor, wherein the processor is configured to activate the fluid transfer mechanism based on input received from the timer.

7. The insect extermination kit as claimed in claim 1 comprising:
at least one sensor; and
the sensor being operatively connected to the processor, wherein the processor is configured to activate the fluid transfer mechanism based on input received from the sensor.

8. The insect extermination kit as claimed in claim 7, wherein the at least one sensor comprising an optical sensor.

9. The insect extermination kit as claimed in claim 1 comprising:
a user interface;
the user interface being externally connected to the housing; and
the user interface being electronically connected to the processor.

10. The insect extermination kit as claimed in claim 9, wherein the user interface comprising an electronics panel.

11. The insect extermination kit as claimed in claim 1, comprising:
a wireless communication device; and
the wireless communication device being electronically connected to the processor.

12. The insect extermination kit as claimed in claim 1 comprising:
a closure; and
the closure being perimetrically positioned along the insect inlet of insect extermination chamber.

13. The insect extermination kit as claimed in claim 1, wherein the insect extermination chamber is a flexible bag.

14. The insect extermination kit as claimed in claim 1, wherein the closure is a drawstring.
